(19) United States
(12) Patent Application Publication
(10) Pub. No.: US 2004/0062937 A1
(43) Pub. Date: Apr. 1, 2004

(54) Flooring system underlayment

(75) Inventor: Laurence F. Lyons, Grayslake, IL (US)

Correspondence Address: FOLEY & LARDNER, 777 EAST WISCONSIN AVENUE, SUITE 3800, MILWAUKEE, WI, 53202-5308, US

(73) Assignee: Amorim Industrial Solutions, Inc.

(21) Appl. No.: 10/662,838

(22) Filed: Sep. 15, 2003

Related U.S. Application Data
(60) Provisional application No. 60/411,135, filed on Sep. 16, 2002.

(51) Int. Cl. B32B 9/04

(52) U.S. Cl. 428/455

(57) ABSTRACT

A floor underlayment includes a first layer, a second layer and a third layer. The first layer includes cork material. The second layer is coupled to the first layer and has a high degree of resistance to moisture permeability. The third layer is coupled to the first layer opposite the second layer. The third layer is configured and formed from at least one material to enhance dimensional stability of the first layer.

### CROSS-REFERENCE TO RELATED APPLICATIONS

The present application claims priority under 35 U.S.C. § 119(e) from co-pending U.S. Provisional Patent Application Serial No. 60/411,135 filed on Sep. 16, 2002 by Laurence F. Lyons, entitled “Flooring System Underlayment,” the full disclosure of which is hereby incorporated by reference.

### FIELD OF THE INVENTION

The present invention relates to flooring systems. In particular, the present invention relates to floor underlayments.

### BACKGROUND OF THE INVENTION

Flooring systems come in a wide variety of different configurations depending upon type of building in which they are employed and their intended use. Flooring systems generally include a finish flooring and a subfloor. Finish flooring is generally the uppermost layer of the flooring system. Known finish flooring materials include wood flooring and resilient flooring. Resilient flooring comprises linoleum, asphalt tiles, vinyl or rubber tiles and the like.

The subfloor is typically the structure of the building which supports the remainder of the floor system. Some subfloor materials include wood, such as plywood, or reinforced concrete. Reinforced-concrete subfloors are especially common in high-rise buildings. The disadvantages of reinforced-concrete subfloors include a lack of resiliency and moisture release. As a result, flooring systems including reinforced-concrete subfloors additionally include a vapor barrier and a separate underlayment. The vapor barrier is usually provided by a sheet of polyethylene film resting upon the reinforced-concrete subfloor. The underlayment usually comprises polyethylene foam or cork sheets resting upon the vapor barrier between the vapor barrier and the finish flooring.

Known flooring systems are generally either free floating or fixed. In free floating flooring systems, the finished flooring typically floats upon the subfloor or the underlayment. In contrast, in fixed flooring systems, the finished flooring is typically adhered or mechanically fastened to the subfloor or underlayment. One known free floating system includes a concrete-reinforced subfloor, an underlayment laminate and a wood laminate finish flooring freely resting upon the underlayment. The underlayment generally comprises polyethylene foam laminated to a polyethylene film which serves as a vapor barrier. Although the underlayment laminate eliminates the need to lay down a separate vapor barrier sheet, this system has several drawbacks. In particular, the polyethylene foam has limited dimensional stability which results in the foam becoming permanently compressed over time. Moreover, polyethylene foam is generally not viewed as environmentally friendly as compared to other known underlayment materials such as cork.

Cork is considered by many to be an environmentally friendly underlayment material. Because cork generally is bark harvested from cork oak trees, it is a natural renewable resource. A typical cork tree produces several hundred kilograms of cork at each harvesting and will survive for many generations. In addition, the cork material used in underlayment is typically recycled material from the wine stopper manufacturing processes.

Cork underlayment is commonly employed in fixed flooring systems. A typical system includes a concrete-reinforced subfloor, a vapor barrier sheet resting upon the subfloor, a 6 millimeter sheet of cork composite (ground cork in a polyurethane binder), sheets of plywood floating upon the cork composite, and a wood finish flooring adhered or fastened to the plywood. The plywood sheets provide a surface upon which the wood finish flooring may be fastened or adhered. Although preferred by many over flooring systems using foam underlayment, systems employing cork underlayment are relatively thick and expensive to install.

### BRIEF DESCRIPTION OF THE DRAWINGS

FIG. 1 is a sectional view of a flooring system of the present invention.

### DETAILED DESCRIPTION OF THE EXAMPLE EMBODIMENT

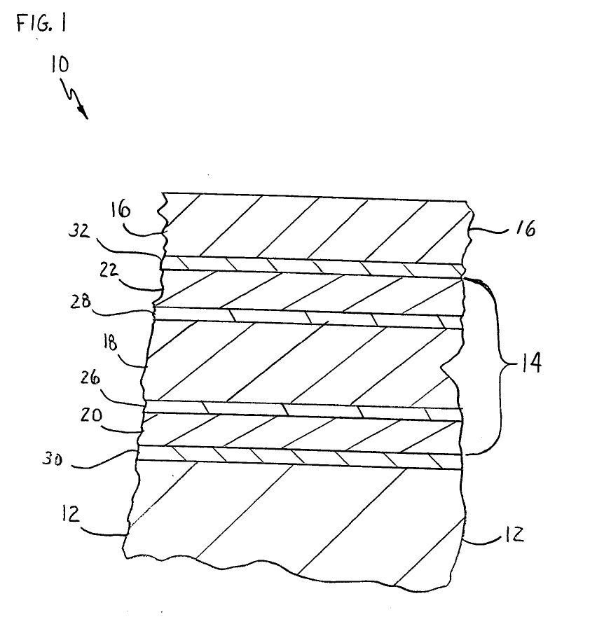

FIG. 1 is sectional view of flooring system 10 which generally includes subfloor 12, floor underlayment 14, and flooring 16. Subfloor 12 is generally the structure of the building which supports the remainder of floor system 10. In the particular embodiment illustrated, subfloor 12 comprises reinforced concrete. The concrete of subfloor 12 is preferably provided in 6-inch slabs of concrete. In alternative embodiments, subfloor 12 may comprise wood such as plywood or oriented strand board (OSB). In those applications where subfloor 12 is formed of plywood, the plywood has a thickness of approximately ⅝ths of an inch.

Floor underlayment 14 extends between subfloor 12 and flooring 16. Underlayment 14 provides several functions including moisture blockage, cushioning and sound attenuation. Underlayment 14 generally includes cork layer 18 and outer layers 20, 22. Cork layer 18 generally comprises a layer of one or more materials including cork. In the particular embodiment illustrated, cork layer 18 comprises ground cork material interspersed in a binder such as polyurethane. In the particular embodiment illustrated, cork layer 18 has a thickness of approximately 6 millimeters. Cork layer 18 preferably comprises a cork composition substantially identical to the cork composition known as Acousticork sold by Amorim of Trevor, Wis. Cork layer 18 has the following characteristics:

| TEST | ASTM TEST | RESULT |
|---|---|---|
| Bond Strength | C482 Modified | PSI of 80 |
| Flame Spread | E84-91a | Class “A” |
| Thermal Insulation | C177-85 | |
| 6 mm AcoustiCORK | | |
| K Factor | (BTU-inch) | 0.320 |
| | (HR-FT²-° F.) | |
| R Factor | (per inch) | 3.125 |

Cork layer 18 generally provides the overall sound attenuation, thermal insulation and cushioning of underlayment 14. Because layer 18 is formed from a cork material, underlayment 14 is environmentally friendly and has greater dimensional stability as compared to foam based materials. Consequently, cork layer 18 is less susceptible to becoming permanently compressed over time.

Exterior layer 20 generally comprises a layer with a high degree of resistance to moisture permability. Layer 20 preferably has a U.S. permeability rating of less than about 1 perm. Preferably, layer 20 has a U.S. permeability rating of approximately 0.40 perm. Layer 20 is coupled to cork layer 18. For purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. Outer layer 20 is preferably adhesively fastened or attached to cork layer 18 by adhesive layer 26. In the particular embodiment illustrated, outer layer 20 comprises a polyethylene film that is treated in a conventionally known manner to better facilitate the adherence of adhesives to layer 20. In the application where layer 20 comprises a polyethylene film, adhesive layer 26 preferably comprises a polyurethane hybrid based adhesive such as Brilliance sold by Venture Coatings Technologies, Inc., of Janesville, Wis. Adhesive layer 26 adheres layer 22 to layer 18 so as to provide a permanent bond having a peel strength of at least 30 ounces per inch and a destructive bond having a peel strength of at least 50 ounces per inch. For purposes of this disclosure, a permanent bond is defined as anything that takes that much force to remove it, i.e., it's intended to be permanent. For purposes of this disclosure, a destructive bond is defined as the amount of force necessary to take a film off of a substrate (in this case cork) that would actually result in the destruction of the surface of the substrate.

Layer 20 preferably has a thickness sufficient so as to form a moisture impermeable barrier or a barrier having a high degree of resistance to moisture permeability adjacent to cork layer 18. As a result, layer 20 inhibits the formation of mold on or in layer 18 and protects layer 18. At the same time, layer 20 preferably has a thickness sufficiently thin so as to minimize the overall thickness of underlayment 14 and so as to provide underlayment 14 with sufficient pliability and flexibility such that underlayment 14 may be formed in sheets which are rolled without damage to underlayment 14. In the particular embodiment illustrated in which layer 20 is formed from polyethylene, layer 20 has a thickness of less than about 5 mils and preferably between 2 and 3 mils.

Outer layer 22 is fastened or attached to cork layer 18 opposite outer layer 20. Outer layer 22 is formed from one or more materials so as to enhance the dimensional stability of cork layer 18. In the particular embodiment illustrated, outer layer 22 is formed from the same or common material as outer layer 20. As a result, outer layer 22 additionally provides a moisture impermeable layer on an opposite side of cork layer 18. This additional layer 22 serves a vapor barrier backup to further block the transmission of water vapor or moisture from subfloor 12 to flooring 16. Layer 22 preferably has a U.S. permeability rating of less than 1 perm. and nominally of about 0.40 perm. Although less desirable, layer 22 may alternatively be formed of one or more materials having greater permeability but still enhancing the structural stability of layer 18. In the particular embodiment where layer 22 is formed from polyethylene, layer 22 is adhesively attached to cork layer 18 by adhesive layer 28 which generally comprises the same adhesive as that of adhesive layer 26. Like layer 20, layer 22 preferably has a maximum thickness which is thin enough to permit underlayment 14 to be formed in sheets and rolled without damage to underlayment 14.

In one particular embodiment, layers 22 and 20 are laminated to cork layer 18 using both heat and pressure. In one embodiment, layers 20 and 22 are laminated to cork layer 18 in a roll-to-roll process having roller temperatures of approximately 180° Fahrenheit and roller pressures of approximately 60 psi. Such lamination is performed at approximately 300 linear feet per hour.

As a whole, underlayment 14 is formed as a sheet having a width of at least about 3 feet. This sheet is sufficiently flexible so as to be rolled. In one particular embodiment, the sheet has a width of about 48 inches.

Underlayment 14 is adhesively adhered to subfloor 12 by an adhesive material that is compatible with both the material of subfloor 12 and the material of layer 20. In the particular embodiment illustrated in which subfloor 12 preferably comprises concrete and in which film 20 comprises polyethylene, layer 20 is adhered to subfloor 12 by adhesive layer 30 comprising a polyurethane based adhesive known as Bostiks Best and sold by Bostik Findley. The destructive bond between subfloor 12 and layer 20 has a peel strength of at least 50 ounces per inch.

Flooring 16 generally comprises the finishing uppermost layer of system 10. In the particular embodiment illustrated, flooring 16 comprises a wood material that is adhesively affixed or adhered to layer 22 of underlayment 14 by adhesive layer 32. Adhesive layer 32 preferably comprises an adhesive material or glue that is compatible with both the underside of flooring 16 and the upper side of layer 22. In the particular embodiment illustrated in which layer 22 comprises polyethylene, adhesive layer 22 comprises a polyurethane based adhesive, such as a blend of polyurethane adhesive and rubber-based adhesive, sold by Bostik Findley. The bond between flooring 16 and layer 22 preferably has a destructive bond having a peel strength of at least about 50 ounces per inch. Alternatively, adhesive layer 32 may be omitted such that flooring 16 simply rests or floats upon underlayment 14.

Overall, floor system provides cushioning, sound attenuation, and moisture or vapor blockage. When underlayment 14 is made from the aforementioned materials having the noted properties, system 10 provides sound attenuation at least as effective as the following sound ratings.

### Sound Ratings for Floor System 10 with Underlayment 14

| | | Cork | | | | Sound | |
|---|---|---|---|---|---|---|---|
| | | Layer | Suspended | | Floor | Ratings | |
| | Subfloor | Thickness | Ceiling | Overlay | Covering | IIC | STC |
| T st R ferenc | | | | | | | |
| (W od Fl or J ist | | | | | | | |
| System) | | | | | | | |
| RAL IN95-19·RAL | 5/8″ | 6 mm | Yes | 1 ½/″ | Parquet | 59 | 54 |
| TL95-126 | Plywood | | | Gypsum | Wood | | |
| | | | | Concrete | | | |
| RAL IN95-15·RAL | 5/8″ | 6 mm | Yes | 1 ½/″ | Laminate | 53 | 60 |
| TL95-122 | Plywood | | | Gypsum | Floor | | |
| | | | | Concrete | | | |
| RAL IN98-37·RAL | 5/8″ | 6 mm | Yes | 1 ½/″ | Floating | 57 | 60 |
| TL98-186 | Plywood | | | Gypsum | Wood | | |
| | | | | Concrete | | | |
| Concrete Floor | | | | | | | |
| System | | | | | | | |
| RAL IN95-43·RAL | 6″ Slab | 6 mm | Yes | None | Glued | 61 | 62 |
| TL95-366 | | | | | Wood | | |
| RAL IN95-42·RAL | 6″ Slab | 6 mm | Yes | None | Nailed | 61 | 61 |
| TL95-365 | | | | | Wood | | |
| RAL IN95-41·RAL | 6″ Slab | 6 mm | Yes | None | Floating | 63 | 60 |
| TL95-364 | | | | | Wood | | |
| RAL IN98-40·RAL | 6″ Slab | 6 mm | No | None | Floating | 50 | 52 |
| TL98-27 | | | | | Wood | | |

The sound attenuation for system 10 was measured using two tests. The impact isolation coefficient (IIC) was based on ASTM testing protocol E492.90 and E989.89. The sound transmission classification (STC) value was obtained using ASTM testing protocol E90-97 and E413-87.

Floor system 10 is generally installed in the following manner. Once a subfloor 12 has been established, underlayment 14, which is preferably in the form of rolled sheets, having a width of at least about 3 feet, is measured and cut to match the dimension of the room. One such method is to unroll the roll in the room and measure the precise length of underlayment 14 that is needed, and then to re-roll the roll. Either before or after measuring underlayment 14, a bed of adhesive layer 13 is applied to subfloor 12. Although less desirable, adhesive layer 13 may alternatively be applied or created upon the underside of layer 20 prior to being placed on subfloor 12. Once underlayment 14 has been placed substantially across the entire surface of subfloor 12 and adhesively affixed to subfloor 12, sealing tape (not shown in FIG. 1) is applied across the joints or cracks between the seats of subfloor 12. This operation may be performed after the entire subfloor 12 is covered with underlayment 14 or as underlayment 14 is placed over subfloor 12. The final operation is the placement of flooring 16 upon subfloor 12. As discussed above, flooring 16 may either be adhered to underlayment 14 by adhesive layer 32, or may simply be rested upon underlayment 14 so as to float.

Although underlayment 14 is illustrated as being employed in floor system 10, underlayment 14 may alternatively be employed in various other floor systems or floor assemblies. For example, underlayment 14 may be employed with a wood subfloor wherein an overlay (such as gypsum concrete) is placed over underlayment 14 between underlayment 14 and flooring 16. Moreover, although underlayment 14 is illustrated as preferably having substantially identical layers 20, 22 of polyethylene adhered on opposite sides of cork layer 18, underlayment 14 may alternatively have alternative layers 20 and 22 having varying thicknesses or being made of different materials. For example, layer 22 may have a lesser thickness as compared to layer 20. Layers 20 and 22 may also be formed from other materials besides treated polyethylene, such as vinyl, polyester (PET) (also known as Mylar), or untreated low-density polyethylene. Although layers 20 and 22 are illustrated as general homogenous one-material layers, layers 20 and 22 may alternatively be formed by multiple materials having differing characteristics intermixed with one another or layered or laminated adjacent to one another. In those applications where layers 20 and 22 are formed from one or more materials other than treated low-density polyethylene, various other presently known or future developed adhesives may be employed to adhesively affix layers 20 and 22 to cork layer 18, and to subfloor 12 and flooring 16, respectively.

Although the present invention has been described with reference to preferred embodiments, workers skilled in the art will recognize that changes may be made in form and detail without departing from the spirit and scope of the invention. For example, although different example embodiments may have been described as including one or more features providing one or more benefits, it is contemplated that the described features may be interchanged with one another or alternatively be combined with one another in the described example embodiments or in other alternative embodiments. Because the technology of the present invention is relatively complex, not all changes in the technology are foreseeable. The present invention described with reference to the example embodiments and set forth in the claims is manifestly intended to be as broad as possible. For example, unless specifically otherwise noted, the claims reciting a single particular element also encompass a plurality of such particular elements.

What is claimed is:

1. A floor underlayment comprising:
a first layer including cork material;
a second layer coupled to the first layer, the second layer having a high degree of resistance to moisture permeability; and
a third layer coupled to the first layer opposite the second layer, wherein the third layer is configured and formed from at least one material to enhance dimensional stability of the first layer.

2. The underlayment of claim 1 wherein the third layer has a high degree of resistance to moisture permeability.

3. The underlayment of claim 1 wherein the first layer, the second layer and the third layer are formed as part of a sheet.

4. The underlayment of claim 3 wherein the sheet is sufficiently flexible to be rolled.

5. The underlayment of claim 3 wherein the sheet has a width of at least about 3 feet.

6. The underlayment of claim 1 wherein the second layer and the third layer each have a thickness of less than about 5 mils.

7. The underlayment of claim 1 wherein the first layer and the third layer are formed from common material.

8. The underlayment of claim 1 wherein at least one of the first layer and the third layer is adapted to be adhered to flooring material.

9. The underlayment of claim 1 wherein the second layer is bonded to the first layer.

10. The underlayment of claim 9 wherein the bond is permanent and has a peel strength of at least 30 ounces per inch.

11. The underlayment of claim 10 wherein the bond has a peel strength of at least about 50 ounces per inch.

12. The underlayment of claim 1 wherein the first layer has a thickness of at least about 2 miles to about 3 miles.

13. The underlayment of claim 1 wherein at least one of the second layer and the third layer have a thickness no greater than about 3 mils.

14. A flooring system comprising:
a concrete subfloor;
a floor underlayment above the subfloor, the underlayment including:
a first layer including cork material;
a second layer attached to the first layer, the second layer being highly resistant to moisture permeability, the second layer located between the first layer and the subfloor; and
a flooring above the floor underlayment.

15. The flooring system of claim 14 wherein the flooring is adhered to the underlayment.

16. The system of claim 1 wherein the first layer consists of cork particles within at least one binder.

17. The flooring system of claim 14 wherein the underlayment includes a third layer coupled to the first layer opposite the second layer, wherein the third layer is formed from a material distinct from the first layer.

18. The flooring system of claim 17 wherein the third layer enhances dimensional stability of the first layer.

19. The flooring system of claim 17 wherein the third layer is bonded to the first layer.

20. The flooring system of claim 18 wherein the third layer is highly resistant to moisture permeability.

21. The flooring system of claim 17 wherein the first layer, the second layer and the third layer are formed as part of a sheet.

22. The flooring system of claim 21 wherein the sheet is sufficiently flexible so as to be rolled.

23. The flooring system of claim 21 wherein the sheet has a width of at least about 3 feet.

24. The flooring system of claim 17 wherein the second layer and the third layer each have a thickness of less than about 5 mils.

25. The flooring system of claim 17 wherein the flooring includes wood material.

26. The flooring system of claim 14 wherein the second layer is bonded to the first layer.

27. The flooring system of claim 26 wherein the bond between the second layer and the first layer is permanent and has a peel strength of at least about 30 ounces per inch.

28. The flooring system of claim 27 wherein the bond is destructive and has a peel strength of at least about 50 ounces per inch.

29. The flooring system of claim 14 wherein an adhesive bonds the flooring and the second layer and wherein the adhesive adheres to the second layer with a peel strength of at least about 50 ounces per inch.

30. The flooring system of claim 14 wherein the second layer has a U.S. perm rating of less than 1 perm.

31. The flooring system of claim 30 wherein the second layer has a U.S. permeability rating of approximately 0.40 perm.
